(19) United States
(12) Patent Application Publication
(10) Pub. No.: US 2014/0322553 A1
(43) Pub. Date: Oct. 30, 2014

(54) SYNTHETIC COLD SEAL ADHESIVE

(71) Applicant: BASF SE, Ludwigshafen (DE)

(72) Inventors: Nicholas Foley, Charlotte, NC (US); Jon A. Debling, Saline, MI (US); Yan Dong, Fort Mill, SC (US)

(21) Appl. No.: 14/363,209

(22) PCT Filed: Dec. 20, 2012
(86) PCT No.: PCT/EP2012/076386

§ 371 Date: Jun. 5, 2014

Related U.S. Application Data
(60) Provisional application No. 61/578,946, filed on Dec. 22, 2011.

(51) Int. Cl. B65D 53/06; B32B 37/12; B32B 7/12

(52) U.S. Cl. CPC B65D 53/06; B32B 7/12; B32B 37/12
USPC 428/516; 428/522; 156/332

(57) ABSTRACT

An adhesively sealed product is disclosed comprising a first surface, a second surface, and an adhesive layer bonding said first surface to said second surface; said adhesive layer comprising a copolymer and a protective colloid, the copolymer being derived from monomers including one or more a C1 to C20 alkyl(meth)acrylates and having a glass transition temperature (Tg) of from −40° C. to 0° C. using differential scanning calorimetry (DSC), wherein opening the product by separating the first surface from the second surface results in adhesive failure of the adhesive layer thereby resulting in a reclosure adhesion of less than 0.5 N/15 mm. A method of producing an adhesively sealed product is also disclosed.

### FIELD

An adhesively sealed product is disclosed comprising a first surface, a second surface, and an adhesive layer bonding said first surface to said second surface, and a method of producing an adhesively sealed product are disclosed herein.

### BACKGROUND

Cold-sealable compositions are bonding compositions which, following application to and drying on a substrate, are not tacky to the touch, yet bond to one another when pressed against one another at room temperature with pressure. They differ from pressure-sensitive adhesives in the absence of, or only very low, tack at room temperature. They differ from heat-sealable compositions in that they can be adhered to one another under pressure without heat activation. Known applications of cold-sealable compositions include, for example, the closing of pouchlike packs, more particularly for foods or other heat-sensitive products in whose packaging the use of heat is undesirable, such as ice cream or chocolate, for example, or when fast packing speeds and high cycle rates are required. Typically, for cold-seal adhesives, polymer dispersions based on natural rubber latex are used. However, natural rubber latex suffers from a comparatively high price volatility, natural fluctuations in the quality of the natural raw material, and the allergenic potential harbored by these natural products. Thus, there is a desire for cold-sealable compositions formed of synthetic materials, which, after drying, form a cold-sealable coating.

In some applications, it is desirable that the package be resealable and suitable formulations for producing resealable packs are described, for example, in U.S. Published Application No. 2011/0152052. However, in some applications, it is important that it can be determined whether or not a package has been previously opened and it is difficult to determine this in resealable packs. Thus, it is desirable to have a sealed package where it can be readily determined whether the package has been previously opened.

### SUMMARY

An adhesively sealed product is disclosed comprising a first surface, a second surface, and an adhesive layer bonding said first surface to said second surface; said adhesive layer comprising a copolymer and a protective colloid, the copolymer being derived from monomers including one or more a C1 to C20 alkyl(meth)acrylates and having a glass transition temperature (T_{g}) of from −40° C. to 0° C. using differential scanning calorimetry (DSC), wherein opening the product by separating the first surface from the second surface results in adhesive failure of the adhesive layer thereby resulting in a reclosure adhesion of less than 0.5 N/15 mm. In some embodiments, the copolymer is derived from at least 50% of one or more C1 to C20 alkyl(meth)acrylates or from at least 70% of one or more C1 to C20 alkyl(meth)acrylates. In some embodiments, the copolymer is a styrene-acrylic-based copolymer and is further derived from one or more of styrene and α-methyl styrene. For example, the copolymer can be derived from styrene in an amount of 30% or less. In some embodiments, the copolymer is a pure acrylic-based copolymer and does not include styrene. In some embodiments, the copolymer is further derived from one or more monomers having carboxylic, amide, and/or hydroxyl groups. For example, the one or more monomers having carboxylic, amide and/or hydroxyl groups include one or more monomers selected from the group consisting of acrylic acid, methacrylic acid, itaconic acid, maleic acid, fumaric acid, (meth)acrylamide, and C1 to C10 hydroxyalkyl(meth)acrylates. In some embodiments, the copolymer can be derived from one or more crosslinking agents such as one or more diacrylate crosslinking agents. In some embodiments, the adhesive layer includes less than 0.1% of a surfactant and can be substantially free of a surfactant. In some embodiments, the copolymer has a weight average molecular weight of greater than 300,000.

In the adhesively sealed product, the adhesive layer can have an initial opening force of less than 3 N/15 mm or less than 2 N/15 mm. In some embodiments, the at least one of the first surface and the second surface is an olefinic film. The first surface and second surface can come from the same substrate.

A method of producing an adhesively sealed product is also disclosed. The method comprises producing a copolymer using emulsion polymerization, said emulsion polymerization comprising polymerizing monomers including one or more C1 to C20 alkyl(meth)acrylates in the presence of a protective colloid in an aqueous medium to produce a copolymer having a glass transition temperature (T_{g}) of from −40° C. to 0° C. using differential scanning calorimetry (DSC); applying the copolymer to a first surface and a second surface; and cold sealing the first surface to the second surface to produce an adhesive layer, wherein opening the product by separating the first surface from the second surface results in adhesive failure of the adhesive layer thereby resulting in a reclosure adhesion of less than 0.5 N/15 mm. The copolymer can include the features described above. In some embodiments, the emulsion polymerization consists of a single polymerization stage. The cold sealing step can be performed at a sealing force of from 25 psi to 100 psi and/or at a temperature from 0° C. to 40° C. (e.g., 15° C. to 30° C.). In some embodiments, the producing step comprises polymerizing monomers in an aqueous medium that includes less than 0.05% of a surfactant or that is substantially free of a surfactant.

The details of one or more embodiments are set forth in the description below. Other features, objects, and advantages will be apparent from the description and from the claims.

### DETAILED DESCRIPTION

As used herein, the term “(meth)acryl . . . ” and similar designations include “acryl . . . or methacryl . . . ”. For example, (meth)acrylic acid would mean acrylic acid or methacrylic acid.

An adhesively sealed product is disclosed herein comprising a first surface, a second surface, and an adhesive layer bonding the first surface to the second surface; the adhesive layer comprising a copolymer and a protective colloid, wherein opening the product by separating the first surface from the second surface results in adhesive failure of the adhesive layer thereby resulting in a reclosure adhesion of less than 0.5 N/15 mm. The adhesively sealed product thus has low resealability as that term is understood in the art. As a result, the adhesively sealed product can be used in applications where it is useful to determine whether the product has been opened before such as in applications where it is important that the product is “tamper proof.”

The copolymer is derived from one or more free-radically polymerizable monomers monomers and operates as a binder in the adhesive layer. The monomers include one or more a C1 to C20 alkyl(meth)acrylates and can further include vinylaromatics having up to 20 C atoms, vinyl esters of carboxylic acids comprising up to 20 C atoms, ethylenically unsaturated nitriles, vinyl halides, vinyl ethers of alcohols comprising 1 to 10 C atoms, aliphatic hydrocarbons having 2 to 8 C atoms and one or two double bonds, or mixtures of these monomers.

Examples include (meth)acrylic acid alkyl esters with a C₁-C₁₀ alkyl radical, such as methyl methacrylate, ethyl acrylate, n-butyl acrylate, n-butyl methacrylate, n-hexyl acrylate, octyl acrylate, 2-ethylhexyl acrylate, 2-propylheptyl acrylate, and mixtures thereof. Suitable vinylaromatic compounds include styrene, α- and p-methylstyrene, α-butylstyrene, 4-n-butylstyrene, 4-n-decylstyrene, vinyltoluene, and mixtures thereof. Vinyl esters of carboxylic acids having 1 to 20 C atoms include, for example, vinyl laurate, vinyl stearate, vinyl propionate, versatic acid vinyl esters, vinyl acetate, and mixtures thereof. Examples of nitriles include acrylonitrile and methacrylonitrile. The vinyl halides can include ethylenically unsaturated compounds substituted by chlorine, fluorine or bromine such as vinyl chloride and vinylidene chloride. The vinyl ethers can include, for example, vinyl ethers of alcohols comprising 1 to 4 C atoms such as vinyl methyl ether or vinyl isobutyl ether. The hydrocarbons having 4 to 8 C atoms and two olefinic double bonds can include butadiene, isoprene, and chloroprene. In some embodiments, the primary monomers include methyl methacrylate, methyl acrylate, n-butyl acrylate, ethyl acrylate, 2-ethylhexyl acrylate, styrene, and mixtures thereof.

In some embodiments, the copolymer is derived from at least 50%, at least 55%, at least 60%, at least 65%, at least 70%, at least 75%, at least 80%, at least 85%, at least 90%, or at least 95% by weight of one or more C1 to C20 alkyl(meth)acrylates. In some embodiments, the copolymer is a styrene-acrylic-based copolymer and is further derived from one or more of styrene and α-methyl styrene. For example, the copolymer can be derived from styrene in an amount of 30% or less, 25% or less, 20% or less, 15% or less, 10% or less, or 5% or less. In some embodiments, the copolymer is a pure acrylic-based copolymer and does not include styrene.

The copolymer can be further derived from one or more functional monomers having carboxylic acid, sulfonic acid, phosphonic acid, amide, and/or hydroxyl groups. For example, the one or more monomers can have carboxylic, amide and/or hydroxyl groups and can include one or more monomers selected from the group consisting of acrylic acid, methacrylic acid, itaconic acid, maleic acid, fumaric acid, (meth)acrylamide, and C1 to C10 hydroxyalkyl(meth)acrylates. Additional functional monomers include phenyloxyethylglycol mono(meth)acrylate, glycidyl acrylate, glycidyl methacrylate, and amino(meth)acrylates such as 2-aminoethyl(meth)acrylate. The copolymer can also include one or more crosslinking agents. For example, one or more diacrylate crosslinking agents such as butanediol diacrylate can be used to form the copolymer.

In some embodiments, the adhesive copolymer has a glass transition temperature of −40° C. to 0° C. or of −30° C. to −5° C. In some embodiments, the glass transition temperature is from −35° C. to −15° C. The glass transition temperature can be determined by differential scanning calorimetry (DSC) by measuring the midpoint temperature using ASTM D 3418-08. In some embodiments, the copolymer has a weight average molecular weight of greater than 300,000, greater than 400,000, greater than 500,000, greater than 600,000, or greater than 700,000.

The adhesive layer also includes a protective colloid and the copolymer is formed in the presence of the protective colloid. Protective colloids are water-soluble polymeric compounds which, on salvation, are capable of stabilizing dispersions of water-insoluble polymers. In contrast to emulsifiers, they generally do not lower the interfacial tension between polymer particles and water. The number-average molecule weight of the protective colloid can be greater than 1000 g/mol or greater than 2000 g/mol, and can be less than 50,000 g/mol or less than 10,000 g/mol. For example, the number-average molecule weight of the protective colloid can be from 1000 to 100,000 g/mol, from 5000 to 50,000 g/mol or from 10,000 to 20,000 g/mol.

The protective colloid can be used in an amount of 0.5 to 60 parts by weight, 1 to 30 parts by weight, 7 to 25 parts by weight, or 10 to 15 parts by weight, based on 100 parts by weight of the monomers to be polymerized. A comprehensive description of protective colloids is given in Houben-Weyl, Methoden der organischen Chemie, Volume XIV/1, Makromolekulare Stoffe [Macromolecular compounds], Georg-Thieme-Verlag, Stuttgart, 1961, pages 411 to 420. Protective colloids contemplated include, for example, amphiphilic polymers that include hydrophobic groups and hydrophilic groups. These can be natural polymers, such as starch, or synthetic polymers.

The protective colloid can be formed from at least 40% by weight of nonionic principal monomers, defined in more detail below, and also from a second kind of monomer, selected from ethylenically unsaturated acid monomers. The protective colloid can, furthermore, be formed optionally from additional monomers such as nonionic monomers. The protective colloid can be produced from 40% to 80% or from 50% to 80% by weight of principal monomers selected from the group consisting of C1 to C20 alkyl(meth)acrylates, vinyl esters of carboxylic acids comprising up to 20 C atoms, vinylaromatics having up to 20 C atoms, ethylenically unsaturated nitriles, vinyl halides, vinyl ethers of alcohols comprising 1 to 10 C atoms, aliphatic hydrocarbons having 2 to 8 C atoms and one or two double bonds, and mixtures of these monomers.

Principal monomers for the protective colloid are, for example, (meth)acrylic acid alkyl esters with a C₁-C₁₀ alkyl radical, such as methyl methacrylate, methyl acrylate, n-butyl acrylate, ethyl acrylate, 2-ethylhexyl acrylate, and mixtures thereof. For example, the principal monomers can be mixtures of the (meth)acrylic acid alkyl esters. Vinyl esters of carboxylic acids having 1 to 20 C atoms include, for example, vinyl laurate, vinyl stearate, vinyl propionate, versatic acid vinyl esters, vinyl acetate, and mixtures thereof. Suitable vinylaromatic compounds include styrene, α- and para-methylstyrene, α-butylstyrene, 4-n-butylstyrene, 4-n-decylstyrene, vinyltoluene, and mixtures thereof. Examples of nitriles include acrylonitrile and methacrylonitrile. The vinyl halides include ethylenically unsaturated compounds substituted by chlorine, fluorine or bromine, such as vinyl chloride and vinylidene chloride. Vinyl ethers include, for example, vinyl ethers of alcohols comprising 1 to 4 C atoms such as vinyl methyl ether and vinyl isobutyl ether. Hydrocarbons having 4 to 8 C atoms and two olefinic double bonds include butadiene, isoprene, and chloroprene. In some embodiments, principal monomers for the protective colloid include C₁ to C₁₀ alkyl acrylates and methacrylates or C₁ to C₈ alkyl acrylates and methacrylates, vinylaromatics such as styrene and alpha-methylstyrene, and mixtures thereof. In some embodiments, the principal monomers include methyl acrylate, methyl methacrylate, ethyl acrylate, n-butyl acrylate, n-butyl methacrylate, n-hexyl acrylate, octyl acrylate, 2-ethylhexyl acrylate, 2-propylheptyl acrylate, styrene, alpha-methylstyrene, and mixtures of these monomers.

The protective colloid can include at least 15% (e.g., from 15% to 60%, from 20% to 55%, or from 30% to 50%) by weight of ethylenically unsaturated acid monomers. Ethylenically unsaturated acid monomers include, for example, ethylenically unsaturated carboxylic acids, ethylenically unsaturated sulfonic acids, and vinylphosphonic acid. In some embodiments, the ethylenically unsaturated carboxylic acids include α,β-monoethylenically unsaturated monocarboxylic and dicarboxylic acids having 3 to 6 C atoms in the molecule. Examples include acrylic acid, methacrylic acid, itaconic acid, maleic acid, fumaric acid, crotonic acid, vinylacetic acid, vinyllactic acid, and mixtures thereof. Suitable ethylenically unsaturated sulfonic acids include, for example, vinylsulfonic acid, styrenesulfonic acid, acrylamidomethylpropanesulfonic acid, sulfopropyl acrylate, sulfopropyl methacrylate, and mixtures thereof. In some embodiments, the ethylenically unsaturated acid monomers include acrylic acid, methacrylic acid, and a mixture thereof. The acid monomers can be used in the form of the free acids and also in a form partially or fully neutralized with suitable bases, for the polymerization. In some embodiments, aqueous sodium or potassium hydroxide solution or ammonia is used as a neutralizing agent.

In one embodiment, the protective colloid (i) is used in an amount of 7% to 30% by weight, based on 100 parts by weight of the monomers to be polymerized, (ii) is composed to an extent of at least 40% by weight of principal monomers selected from the group consisting of C1 to C20 alkyl(meth)acrylates, vinyl esters of carboxylic acids comprising up to 20 C atoms, vinylaromatics having up to 20 C atoms, ethylenically unsaturated nitriles, vinyl halides, vinyl ethers of alcohols comprising 1 to 10 C atoms, aliphatic hydrocarbons having 2 to 8 C atoms and one or two double bonds, and mixtures of these monomers, (iii) is composed to an extent of at least 15% by weight of ethylenically unsaturated acid monomers such as acrylic acid, methacrylic acid, itaconic acid, and a mixture thereof, and (iv) has a number-average molecular weight of 1000 to 10 000. In some embodiments, the protective colloid is derived from monomers including one or more C1 to C20 alkyl(meth)acrylates (e.g., butyl acrylate, ethyl acrylate and methyl methacrylate) and one or more ethylenically unsaturated carboxylic acids (e.g., acrylic acid), and can optionally further include styrene. The protective colloid can have a T_{g} from −20° C. to 60° C. or from −10° C. to 40° C.

The copolymer can be prepared by emulsion polymerization in an aqueous medium in the presence of the protective colloid, which acts as a stabilizer during the polymerization. The emulsion polymerization can optionally be carried out in the presence of one or more ionic and/or nonionic surfactants, which help maintain the dispersion of the monomers in the aqueous medium. In some embodiments, the above-mentioned protective colloids can be used as the sole dispersant, i.e., without the addition of surfactants. If desired, however, small amounts of surfactants can also be used as well. For example, the dispersion can include less than 3% by weight or less than 1% by weight of surfactants. In some embodiments, the dispersion is substantially free of surfactants and can include less than 0.05% or less than 0.01% by weight of one or more surfactants. In some embodiments, the resulting adhesive layer including the copolymer includes less than 0.1% of a surfactant and can be substantially free of a surfactant.

The surfactants can include anionic or nonionic surfactants. Suitable surfactants include ethoxylated C₈ to C₃₆ or C₁₂ to C₁₈ fatty alcohols having a degree of ethoxylation of 3 to 50 or of 4 to 30, ethoxylated mono-, di-, and tri-C₄ to C₁₂ or C₄ to C₉ alkylphenols having a degree of ethoxylation of 3 to 50, alkali metal salts of dialkyl esters of sulfosuccinic acid, alkali metal salts and ammonium salts of C₈ to C₁₂ alkyl sulfates, alkali metal salts and ammonium salts of C₁₂ to C₁₈ alkylsulfonic acids, and alkali metal salts and ammonium salts of C₉ to C₁₈ alkylarylsulfonic acids. Cationic emulsifiers are, for example, compounds having at least one amino group or ammonium group and at least one C₈-C₂₂ alkyl group. Other suitable emulsifiers are compounds of the general formula

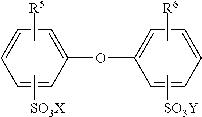

in which R⁵ and R⁶ are hydrogen or C₄ to C₁₄ alkyl but are not simultaneously hydrogen, and X and Y can be alkali metal ions and/or ammonium ions. In some embodiments, R⁵ and R⁶ are linear or branched alkyl radicals having 6 to 18 C atoms or hydrogen. X and Y can be sodium, potassium or ammonium ions. In some embodiments, the compounds of the general formula are compounds in which X and Y are sodium, R⁵ is a branched alkyl radical having 12 C atoms, and R⁶ is hydrogen or R⁵. The surfactants can be technical mixtures which comprise a fraction of 50% to 90% by weight of the monoalkylated product, an example being Dowfax™ 2A1 (Dow Chemical Company). Suitable surfactants are also found in Houben-Weyl, Methoden der organischen Chemie, volume 14/1, Makromolekulare Stoffe, Georg Thieme Verlag, Stuttgart, 1961, pages 192 to 208. Exemplary surfactants include Dowfax™ 2 A1, Emulan™ NP 50, Dextrol™ OC 50, Emulgator 825, Emulgator 825 S, Emulan™ OG, Texapon™ NSO, Nekanil™ 904 S, Lumiten™ 1-RA, Lumiten™ E 3065, Disponil™ FES 77, Lutensol™ AT 18, Steinapol™ VSL, and Emulphor™ NPS 25. Also suitable are copolymerizable emulsifiers which comprise a free-radically polymerizable, ethylenically unsaturated double bond, examples being reactive anionic emulsifiers such as Adeka™ Resoap SR-10.

The emulsion polymerization can take place at a polymerization temperature of 30° C. to 130° C. or 50° C. to 90° C. The polymerization medium can include only water or can be a mixture of water and a water-miscible liquid such as methanol, ethanol or tetrahydrofuran. In some embodiments, the polymerization medium is free of organic solvents and includes only water. The emulsion polymerization can be carried out either as a batch operation or in the form of a feed process, including staged or gradient procedures. In some embodiments, a portion of the polymerization batch is made the initial charge, heated to the polymerization temperature, and partially polymerized, and then the remainder of the polymerization batch, usually by way of two or more spatially separate feeds, of which one or more comprise the monomers in pure form or in emulsified form, is supplied continuously or else in stages. In some embodiments, the copolymer is produced in a single stage (i.e., does not include separate feeds having different monomer compositions so as to produce a multistage polymer particle such as a core/shell particle).

The emulsion polymerization is carried out in the presence of at least one protective colloid. This means that the protective colloids are included in the initial charge or supplied together with monomers to the polymerization vessel. In some embodiments, the protective colloid is included in the initial emulsion polymerization charge and any additionally employed surfactant can be supplied with the initial charge or with the monomers in the course of the polymerization. In some embodiments, the protective colloid is prepared in situ prior to the addition of the monomers used to form the copolymer.

For the emulsion polymerization, it is possible to use auxiliaries, such as water-soluble initiators and regulators. Examples of water-soluble initiators for the emulsion polymerization are ammonium salts and alkali metal salts of peroxodisulfuric acid, e.g., sodium peroxodisulfate, hydrogen peroxide or organic peroxides, e.g., tert-butyl hydroperoxide. Reduction-oxidation (redox) initiator systems are also suitable as initiators for the emulsion polymerization. The redox initiator systems are composed of at least one, usually inorganic, reducing agent and one organic or inorganic oxidizing agent. The oxidizing component comprises, for example, the initiators already specified above for the emulsion polymerization. The reducing components are, for example, alkali metal salts of sulfurous acid, such as sodium sulfite, sodium hydrogen sulfite, alkali metal salts of disulfurous acid such as sodium disulfite, bisulfite addition compounds with aliphatic aldehydes and ketones, such as acetone bisulfite, or reducing agents such as hydroxymethanesulfinic acid and salts thereof, or ascorbic acid. The redox initiator systems can be used in the company of soluble metal compounds whose metallic component is able to exist in a plurality of valence states. Typical redox initiator systems include, for example, ascorbic acid/iron(II) sulfate/sodium peroxodisulfate, tert-butyl hydroperoxide/sodium disulfite, tert-butyl hydroperoxide/Na hydroxymethanesulfinate, or tert-butyl hydroperoxide/ascorbic acid. The individual components, the reducing component for example, can also be mixtures, an example being a mixture of the sodium salt of hydroxymethanesulfinic acid with sodium disulfite. The stated compounds are used usually in the form of aqueous solutions, with the lower concentration being determined by the amount of water that is acceptable in the dispersion, and the upper concentration by the solubility of the respective compound in water. The concentration can be 0.1% to 30%, 0.5% to 20%, or 1.0% to 10%, by weight, based on the solution. The amount of the initiators is generally 0.1% to 10% or 0.5% to 5% by weight, based on the monomers to be polymerized. It is also possible for two or more different initiators to be used in the emulsion polymerization. For the removal of the residual monomers, an initiator can be added after the end of the emulsion polymerization.

In the polymerization it is possible to use molecular weight regulators or chain transfer agents, in amounts, for example, of 0 to 0.8 parts by weight, based on 100 parts by weight of the monomers to be polymerized, to reduce the molecular weight of the copolymer. Suitable examples include compounds having a thiol group such as tert-butyl mercaptan, thioglycolic acid ethylacrylic esters, mercaptoethanol, mercaptopropyltrimethoxysilane, and tert-dodecyl mercaptan. Additionally, it is possible to use regulators without a thiol group, such as terpinolene. In some embodiments, the emulsion polymer is prepared in the presence of greater than 0% to 0.5% by weight, based on the monomer amount, of at least one molecular weight regulator. In some embodiments, the emulsion polymer is prepared in the presence of less than less than 0.3% or less than 0.2% by weight (e.g., 0.10% to 0.15% by weight) of the molecular weight regulator.

The resulting copolymer dispersion has a solids content from 15% to 75% or 40% to 60% by weight. In some embodiments, the copolymer dispersion has a solids content of greater than 50%. The solids content can be adjusted, for example, by appropriately adjusting the monomer amounts and/or the amount of water used in the emulsion polymerization. The average particle size of the polymer particles dispersed in the aqueous dispersion can be less than 400 nm, or less than 300 nm. In some embodiments, the average particle size is between 140 and 250 nm. By average particle size here is meant the d₅₀ value of the particle size distribution, i.e., 50% by weight of the total mass of all the particles have a smaller particle diameter than the d₅₀ figure. The particle size distribution can be determined in a known way using the analytical ultracentrifuge (W. Machtle, Makromolekulare Chemie 185 (1984), pp. 1025-1039). The pH of the polymer dispersion can be more than 4, e.g., between 5 and 9. The dispersion has a viscosity of less than 1200 cP at 25° C.

The adhesive composition can be composed solely of the copolymer dispersion and the protective colloid or it can include additional additives. Suitable additives include fillers, antiblocking agents, dyes, flow control agents, and thickeners.

The adhesively sealed product is produced by applying the copolymer to a first surface and a second surface and cold sealing the first surface to the second surface to produce an adhesive layer. The adhesive layer, following application to a substrate and following drying, forms a coating which at room temperature is autoadhesive and is blocking-resistant with respect to polyamide surfaces. For example, the blocking resistance with the polyamide can be less than 0.75 N/15 mm.

The adhesive sealed product can be a package wherein the surface of one substrate is coated is coated at the points which are to be adhered with a copolymer adhesive layer, the surface of another substrate is coated at the points which are to be adhered with a copolymer adhesive layer, and the two surfaces are placed in contact under a sealing force to form the adhesively sealed product. In some embodiments, the first surface and second surface can come from the same substrate.

Substrates contemplated for bonding include any desired substrates, examples being substrates made of wood, metal, paper or plastic, which can be bonded to one another in any desired combination. In some embodiments, at least one substrate is a polymer film. Coating of the substrates can take place in a conventional manner, such as by printing including flexographic printing or by gravure printing (intaglio printing). The coat thickness (after drying) can be 1 to 30 g/m², 1 to 10 g/m², or 1 to 5 g/m². The adhesive can be used to produce packaging. Packaging contemplated is that composed of any desired materials, such as of paper or plastic. Examples include packaging made from polymer films, including, if desired, metallized polymer films, e.g., of polyethylene, polypropylene, PVC, polyester and/or polyacetate. In some embodiments, the substrate is an oriented olefinic film such as polypropylene, polyethylene, polyethylene terephthalate, or polystyrene. In some embodiments, the film is bonded to itself to produce the adhesively sealed product.

In some packaging, a carrier coated on both sides can be used. The carrier has on one side (referred to as the face) an outer layer of the adhesive, and having on the other side (referred to as the reverse) an outer release coating. The carrier can be composed, for example, of one of the above-mentioned polymer films, or metallized polymer films. The polymer films can also have been corona-pretreated. The adhesive can be coated directly onto the face of the carrier, although between the carrier and the adhesive there can also be other layers, examples being primer layers, barrier layers, or colored or monochrome printing-ink layers. The printing ink layers can also be located on the reverse of the carrier. The adhesive layer is located on the outside of the layers coating the carrier.

The release coating can be of any desired material, and can be a polymer film, e.g., a film of oriented polypropylene, which is laminated on or coextruded, or a liquid varnish, such as a polyamide lacquer, for example, which is applied and filmed. It is desirable that the adhesive layer applied to the face of the carrier does not adhere to the release coating (has blocking resistance). The carrier is generally rolled up and later processed from the roll. In the course of rolling, the face and the reverse of the carrier come into direct contact. Adhesion of the face to the reverse would make the carrier unusable. Between the release coating and the carrier, there can be further layers; those contemplated include, in turn, layers of a primer which improves the adhesion, and printing ink layers. Another function of the outer release coating is to protect the lower layers, such as the printing ink layer, from external exposure.

In some embodiments, the carriers have the following construction, the sequence of the layers corresponds to the spatial arrangement:

adhesive layer/carrier/optional primer layer/optional printing ink layer/release coating.

The adhesive can also be used to produce a coated polymer film, where a polymer carrier film is coated at least partly, i.e., at least at the areas forming the subsequent sealed seam, with the adhesive layer. The polymer film can have a first side and a second side, the first side being an outer layer being coated at least partly with the adhesive, and the second side having as an outer layer a release coating. In one embodiment the polymer carrier film of the coated polymer film is composed of oriented polyethylene or oriented polypropylene, and the release coating is formed of a polyamide lacquer. Suitable polymer films include Oppalyte™ HM 40, Oppalyte™ HM30 and Oppalyte™ 33MW247, surface-treated, biaxially oriented polypropylene films from Exxon Mobil Corp. and Treofan™ SHD40, an oriented polypropylene film from Treofan GmbH & Co. KG. A suitable polyamide lacquer for use as the release coating is Gecko™ Coldseal Release varnish 70 GL 282547, a solvent-based, polyamide release varnish, from Huber Group.

The double-sided coated carrier can be bonded to itself or the coated polymer film can be bonded to itself by cold sealing, with the adhesive layers brought into contact with each other at the points that are to be bonded to produce a package to produce a sealed seam. The packaging can be sealed together by cold sealing of the adhesive layer as soon as the packaged contents have been introduced. The cold sealing can be performed at a sealing force of from 25 psi to 100 psi or from 60 to 80 psi for a sealing time, i.e., the time during which the pressure is maintained, from 0.1 to 20 seconds, 0.1 to 3 seconds (e.g., 0.5 seconds). The cold sealing temperature can be from 0° C. to 40° C. (e.g., 15° C. to 30° C. or 20° C. to 25° C.). The packaged contents can include, for example, comestibles.

In the adhesively sealed product, the adhesive layer can have an initial opening force of less than 3 N/15 mm, less than 2.5 N/15 mm less than 2 N/15 mm, or less than 1.8 N/15 mm and greater than 0.5 N/15 mm, greater than 1 N/15 mm, or greater than 1.5 N/15 mm, as measured by the method described herein. Opening the adhesive product by separating the first surface from the second surface results in adhesive failure of the adhesive layer thereby resulting in a reclosure adhesion of less than 0.5 N/15 mm at 20° C., as measured by the method described herein. As a result, when the package is opened, it tends to adhere only to one of the surfaces it was originally adhered to and to separate from the other surface. This can readily be determined by using colored chalk to determine the location of the adhesive after opening of the package. Thus, the adhesive layer once opened has low resealability and provides a tamper proof package.

The initial opening force and reclosure adhesion consistently occur within the above ranges under room temperature and low humidity conditions, normal conditions (room temperature and 50% relative humidity) and at an elevated temperature and humidity (e.g., 37° C. and 95% relative humidity).

The adhesively sealed products described herein are cold sealable, have desired blocking resistance, and provide a tamper proof seal. The blocking-resistance means that the adhesion of a surface coated with the adhesive and dried, i.e., the adhesion of an unsealed layer of adhesive with respect to a polyamide surface, after applying a constant force of 100 psi for one day at 25° C., is not more than 0.75 N/15 mm, as measured by the method described herein. The adhesive is free from the allergenic potential from organic solvents, and can be applied effectively by conventional application technologies (such as printing, for example) to substrates such as film substrates.

The examples below are intended to further illustrate certain aspects of the methods and compositions described herein, and are not intended to limit the scope of the claims. Parts and percentages are provided on a weight basis herein, unless indicated otherwise.

### EXAMPLES

### Example 1

| | Component % |
|---|---|
| | (weight) |
| Water | 44.56% |
| Seed Latex | 0.16% |
| Sodium persulfate | 0.44% |
| t-Dodecyl mercaptan | 0.14% |
| Ethyl acrylate | 9.52% |
| Acrylic acid | 1.36% |
| Butyl acrylate | 32.60% |
| Butanediol Diacrylate | 0.03% |
| Styrene | 10.88% |
| Ammonium Hydroxide | 0.22% |
| Sodium metabisulfite | 0.11% |

The monomers listed above were polymerized using a semi-batch process in the presence of tert-dodecyl mercaptan (t-ddm) and a sodium persulfate initiator. The polymers were prepared using a polystyrene seed latex. The protective colloid was prepared in situ from the acrylic acid and ethyl acrylate monomers and had a T_{g} of −7° C. The acid functionality of the copolymer prepared according to this method was partially neutralized using ammonium hydroxide. The final copolymer had a Tg of −16° C. using DSC.

### Example 2

| | Component % |
|---|---|
| | (weight) |
| Water | 42.51% |
| Protective Colloid | 5.17% |
| Ammonium Hydroxide | 0.23% |
| Sodium persulfate | 0.26% |
| t-Dodecyl mercaptan | 0.08% |
| Butyl Acrylate | 36.20% |
| Methyl Methacrylate | 12.35% |
| Butanediol Diacrylate | 0.01% |
| Hydroxyethyl Acrylate | 3.10% |
| t-Butyl Hydroperoxide | 0.05% |
| Ascorbic Acid | 0.05% |

The monomers listed above were polymerized using a semi-batch process in the presence of tert-dodecyl mercaptan (t-ddm), tert-butyl hydroperoxide, ascorbic acid and a sodium persulfate initiator. The monomers were polymerized in the presence of a protective colloid comprising an acrylic acid/butyl acrylate copolymer having a T_{g} of 6° C. The acid functionality of the polymer prepared according to this method was partially neutralized using ammonium hydroxide. The final copolymer had a Tg of −17° C. using DSC.

### Example 3

| | Component % |
|---|---|
| | (weight) |
| Water | 44.93% |
| Ethyl Acrylate | 3.54% |
| Seed Latex | 0.16% |
| Itaconic Acid | 0.68% |
| Methyl Acrylate | 6.60% |
| Butyl Acrylate | 37.75% |
| Methyl Methacrylate | 5.41% |
| Butanediol Diacrylate | 0.11% |
| Ammonium Hydroxide | 0.19% |
| Sodium Persulfate | 0.34% |
| t-Dodecyl Mercaptan | 0.08% |
| Sodium Metabisulfite | 0.21% |

The monomers listed above were polymerized using a semi-batch process in the presence of tert-dodecyl mercaptan (t-ddm) and a sodium persulfate initiator. The polymers were prepared using a polystyrene seed latex. The protective colloid was prepared in situ from the itaconic acid, ethyl acrylate and methyl acrylate monomers and had a T_{g} of +7° C. The acid functionality of the copolymer prepared according to this method was partially neutralized using ammonium hydroxide. The final copolymer had a Tg of −33° C. using DSC.

### Test Procedures

Coating with Polyamide Release Varnish

A 0.07 mm wire applicator is used to apply Gecko™ Coldseal Release solvent-based, polyamide varnish 70 GL 282547 (Huber Group) to the pretreated side of Oppalyte™ HM40 OPP (oriented polypropylene) film, and the applied varnish is dried with hot air for 10 seconds. The release varnish application rate is about 1.0 g/m².

Coating of the OPP Film

With the bar applicator, the adhesive is applied to the pretreated side of the OPP film Oppalyte™ HM40 (a surface-treated, biaxially oriented polypropylene, from Exxon Mobil Corp.) and dried at 70° C. for 1 minute. The coated film is lined with an OPP film coated with release varnish.

Sealed Seam Strength (SSS)

Strips 1 inch wide are cut from the coated film and sealed to one another (adhesive to adhesive) on the sealing device for 0.5 second with 60 psi. Within 5 minutes after sealing has taken place, the peel strengths in lb/ft or N/15mm are determined at a peel speed of 300 mm/min using a 180° Peel Test.

Blocking Test

The coated film is placed against the release-varnish-coated side of an Oppalyte™ HM40 OPP film, held under a constant force of 100 psi for 1 day at 25° C. Thereafter, the peel strengths of strips 1 inch wide are determined in lb/ft or N/15mm, with a peel speed of 800 mm/min.

Reclose Strength

The test specimens are produced as for the testing of the sealed seam strength, and are likewise sealed to one another. The seal is then opened and pressed closed again with a sealing force of 20 psi. The sealed seam strength determined then is the peel strength in lb/ft or N/15mm after closing using a 180° Peel Test.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative materials and method steps disclosed herein are specifically described, other combinations of the materials and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated. The term “comprising” and variations thereof as used herein is used synonymously with the term “including” and variations thereof and are open, nonlimiting terms. Although the terms “comprising” and “including” have been used herein to describe various embodiments, the terms “consisting essentially of” and “consisting of” can be used in place of “comprising” and “including” to provide for more specific embodiments and are also disclosed.

1. An adhesively sealed product, comprising:
a first surface;
a second surface; and
an adhesive layer bonding said first surface to said second surface; said adhesive layer comprising a copolymer and a protective colloid, the copolymer being derived from monomers including one or more C1 to C20 alkyl(meth)acrylates, and the copolymer having a glass transition temperature (T_{g}) of from −40° C. to 0° C. using differential scanning calorimetry (DSC),
wherein opening the product by separating the first surface from the second surface results in adhesive failure of the adhesive layer thereby resulting in a reclosure adhesion of less than 0.5 N/15 mm.

2. The product according to claim 1, wherein the copolymer is derived from at least 50% of the one or more C1 to C20 alkyl(meth)acrylates.

3. The product according to claim 1, wherein the copolymer is derived from at least 70% of the one or more C1 to C20 alkyl(meth)acrylates.

4. The product according to claim 1, wherein the copolymer is a styrene-acrylic-based copolymer and is further derived from one or more of styrene and α-methyl styrene.

5. The product according to claim 4, wherein the copolymer is derived from styrene in an amount of 30% or less.

6. The product according to claim 1, wherein the copolymer is a pure acrylic-based copolymer and does not include styrene.

7. The product according to claim 1, wherein the copolymer is further derived from one or more monomers having carboxylic, amide, and/or hydroxyl groups.

8. The product according to claim 7, wherein the one or more monomers having carboxylic, amide and/or hydroxyl groups include one or more monomers selected from the group consisting of acrylic acid, methacrylic acid, itaconic acid, maleic acid, fumaric acid, and (meth)acrylamide.

9. The product according to claim 7, wherein the one or more monomers having carboxylic, amide, and/or hydroxyl groups include a C1 to C 10 hydroxyalkyl(meth)acrylate.

10. The product according to claim 1, wherein the copolymer is derived from one or more crosslinking agents.

11. (canceled)

12. (canceled)

13. The product according to claim 1, wherein the protective colloid is derived from monomers including one or more C1 to C20 alkyl(meth)acrylates and one or more ethylenically unsaturated carboxylic acids.

14. The product according to claim 1, wherein the adhesive layer includes less than 0.1% of a surfactant.

15. The product according to claim 1, wherein the adhesive layer is substantially free of a surfactant.

16. The product according to claim 1, wherein the copolymer has a weight average molecular weight of greater than 300,000.

17. The product according to claim 1, wherein the adhesive layer has an initial opening force of less than 3 N/15 mm.

18. (canceled)

19. The product according to claim 1, wherein at least one of the first surface and the second surface is an olefinic film.

20. The product according to claim 1, wherein the first surface and second surface come from the same substrate.

21. A method of producing an adhesively sealed product, comprising:
producing a copolymer using emulsion polymerization, said emulsion polymerization comprising polymerizing monomers including one or more C1 to C20 alkyl(meth)acrylates in the presence of a protective colloid in an aqueous medium to produce a copolymer having a glass transition temperature (T_{g}) of from −40° C. to 0° C. using differential scanning calorimetry (DSC);
applying the copolymer to a first surface and a second surface; and
cold sealing the first surface to the second surface to produce an adhesive layer,
wherein opening the product by separating the first surface from the second surface results in adhesive failure of the adhesive layer thereby resulting in a reclosure adhesion of less than 0.5 N/15 mm.

22. The method according to claim 21, wherein said cold sealing step is performed at a sealing force of from 25 psi to 100 psi.

23. The method according to claim 21, wherein said cold sealing step is performed at a temperature from 15° C. to 30° C.

24. (canceled)

25. (canceled)

26. (canceled)

27. (canceled)

28. (canceled)

29. (canceled)

30. (canceled)

31. (canceled)

32. (canceled)

33. (canceled)

34. The method according to claim 21, wherein said emulsion polymerization consists of a single polymerization stage.

35. (canceled)

36. (canceled)

37. (canceled)

38. (canceled)

39. (canceled)
